(19) United States
(12) Patent Application Publication
(10) Pub. No.: US 2009/0265187 A1
(43) Pub. Date: Oct. 22, 2009

(54) Systems and Methods for Storing and Locating Claim Reimbursement Attachments

(75) Inventors: Keith W. Boone, Randolph, MA (US); Pradip Kumar Parida, Hyderbad (IN); Trivedi Bodlapati, Bangalore (IN)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/106,922

(22) Filed: Apr. 21, 2008

(51) Int. Cl. G06Q 50/00; G06F 17/30; G06F 7/06

(52) U.S. Cl. 705/3; 707/104.1; 707/3; 707/E17.008

(57) ABSTRACT

Certain embodiments of the present invention provide a clinical document storage and locator system including a clinical database component, a document retriever component, and a query mapper component. The clinical database component is adapted to store a plurality of clinical documents. The document retriever component is adapted to receive a request. The document retriever component is further adapted to determine an LOINC code using the received request. The query mapper component is adapted to generate a document query using the determined LOINC code. The document retriever component is adapted to retrieve a relevant clinical document from the clinical database component using the generated document query.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to clinical document management systems. More specifically, the present invention relates to systems and methods for storing and locating claim reimbursement attachments.

After a healthcare provider has provided a healthcare service or product to a patient, the healthcare provider may submit a claim for reimbursement for the service or product. The claim may be submitted to a payer, such as the patient, the patient's insurer, or another payer, for example. That claim may be accompanied by documentation identifying characteristics relating to the treatment and/or outcome, such as an LOINC code, for example. Supporting documentation, such as medical records, for example, may need to be attached to the claim. The claim may be a X12N 837 claim, for example.

After submission of the claim, the healthcare provider may send a claim status inquiry, such as an X12N 276 inquiry, to inquire about and monitor an outstanding claim.

In certain circumstances, the insurer or any other payer of a claim may request additional documentation before paying the claim for a medical service or treatment. The payer may send the healthcare provider a request for additional information about the claim, such as an X12N 277 request, for example.

The request for additional information may require a response, such as an X12N 275 response, for example, with attached clinical documents, such as medical records, for example.

Certain standards govern the mechanisms for attaching documents to a claim or to respond to a request for additional information, such as the Health Level Seven (HL7) Clinical Document Architecture (CDA) standard, for example.

The medical industry provides a variety of standards relating to tracking health and laboratory information. In particular, Logical Observation Identifiers Names and Codes (LOINC) provides a set of universal names and ID codes for identifying clinical documents, and laboratory and clinical test results. It was developed and is maintained by the Regenstrief Institute, Inc., a non-profit medical research organization. The LOINC database facilitates the exchange and pooling of results for clinical care, outcomes management, and research.

Currently, some laboratories and other diagnostic services use HL7 to send their results electronically from their reporting systems to their care systems. HL7 is a standards organization that is accredited by the American National Standards Institute (ANSI). HL7 and its members provide a framework (and related standards) for the exchange, integration, sharing, and retrieval of electronic health information.

However, most laboratories and other diagnostic care services identify tests by means of their internal and idiosyncratic code values. Thus, to fully “understand” and properly file the results, each healthcare system may either adopt the producer's laboratory codes (which may not be possible if the system receives results from multiple sources), or invest in the work to map each result producer's code system to the healthcare system's internal code system. LOINC codes may act as universal identifiers for laboratory and other clinical observations and clinical documents.

A universal code system may enable facilities and departments across the world to receive and send results for comparison and consultation, and contribute toward a larger public health initiative of improving clinical outcomes and quality of care. LOINC is one of the standards for use in U.S. Federal Government systems for the electronic exchange of clinical health information. In 1999, LOINC was identified by the HL7 Standards Development Organization as a preferred code set for clinical documents in transactions between health care facilities, laboratories, laboratory testing devices, and public health authorities.

In the healthcare industry, revenue loss to the provider due to inefficient claims processing may occur due at least in part to the unavailability or slow retrieval of relevant clinical documents required as evidence to be furnished to the payers. The processing by the provider, which is largely manual and involves disparate clinical and revenue management systems, results in multiple communications back and forth between payers and providers. This leads to delay and/or rejection of payment, which in turn results in delay in revenue collection and/or revenue losses to the provider.

The LOINC applies universal code names and identifiers to medical terminology related to an electronic health record. The purpose is to assist in the electronic exchange and gathering of clinical results, such as laboratory tests, clinical observations, outcomes management, and clinical research.

### BRIEF SUMMARY OF THE INVENTION

Certain embodiments of the present invention provide a clinical document storage and locator system including a clinical database component, a document retriever component, and a query mapper component. The clinical database component is adapted to store a plurality of clinical documents. The document retriever component is adapted to receive a request. The document retriever component is further adapted to determine an LOINC code using the received request. The query mapper component is adapted to generate a document query using the determined LOINC code. The document retriever component is adapted to retrieve a relevant clinical document from the clinical database component using the generated document query.

Certain embodiments of the present invention provide a clinical document storage and locator system including a clinical database component, a user interface component, a document retriever component, and a temporary storage component. The clinical database component is adapted to store a plurality of clinical documents and a plurality of clinical document identifiers. The user interface component is adapted to receive a user query. The document retriever component is adapted to retrieve a relevant clinical document identifier from the clinical database component using the received user query. The user interface component is adapted to display the retrieved relevant clinical document identifier for selection by a user. The document retriever component is further adapted to retrieve a relevant clinical document associated with the displayed relevant clinical document identifier from the clinical database component. The temporary storage component is adapted to store the retrieved relevant clinical document. The document retriever component is further adapted to attach the stored relevant clinical document to a response.

Certain embodiments of the present invention provide a method for locating claim reimbursement attachments including receiving a request, determining an LOINC code using the request, generating a document query using the LOINC code, and retrieving a relevant clinical document from a clinical database component using the document query.

Certain embodiments of the present invention provide a method for locating claim reimbursement attachments including receiving a user query, retrieving a relevant clinical document identifier using the user query, displaying the relevant clinical document identifier for selection by a user, retrieving the relevant clinical document, caching the retrieved relevant clinical document, and attaching the cached relevant clinical document to a response. The relevant clinical document identifier is associated with a relevant clinical document.

Certain embodiments of the present invention provide a computer-readable medium comprising a set of instructions for execution on a computer, the set of instructions including a receiver routine, an LOINC routine, a generation routine, and a retrieval routine. The receiver routine is configured to receive a request. The LOINC routine is configured to determine an LOINC code using the request. The generation routine is configured to generate a document query using the determined LOINC code. The retrieval routine is configured to retrieve a relevant clinical document from a clinical database component using the generated document query.

### BRIEF DESCRIPTION OF SEVERAL VIEWS OF THE DRAWINGS

FIG. 1 illustrates a clinical document storage and locator system according to an embodiment of the present invention.

FIG. 2 illustrates a clinical document storage and locator system according to an embodiment of the present invention.

FIG. 3 illustrates a clinical document storage and locator system according to an embodiment of the present invention.

FIG. 4 illustrates a flow diagram for a method for retrieving clinical documentation according to an embodiment of the present invention.

FIG. 5 illustrates a flow diagram for a method for retrieving clinical documentation according to an embodiment of the present invention.

FIG. 6 illustrates a user interface according to an embodiment of the present invention.

FIG. 7 illustrates a clinical document storage and locator system according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention support multiple suppliers of clinical documents within and/or across different enterprises. Certain embodiments may allow healthcare providers to access clinical documents to submit a claims attachment, which have originated from other enterprise, such as a discharge summary or operative note, for example.

Certain embodiments of the present invention classify clinical documents along several axes to enable queries using a single LOINC document classification code. The use of multiple classifications for a clinical document assists with insurance claims processing. Certain embodiments of the present invention use subsumption and/or IS-A hierarchies within several of these axes to support identification of documents that might be correctly classified using more than one LOINC code.

Certain embodiments of the present invention help process claims faster, improve the functioning of a healthcare provider's accounts receivable department, reduce claims write offs, improve productivity in claims processing, and reduce manual intervention and human errors in claims processing.

Certain embodiments of the present invention provide a user-configurable rule for document creation and submission, automatic notification of availability of all needed documents based on business rules for claims processing, an intuitive interface to enable quick searching for needed documents if manual intervention is needed, better communication and interaction between healthcare providers and payers, and end-to-end automation of the claim processing attachment process.

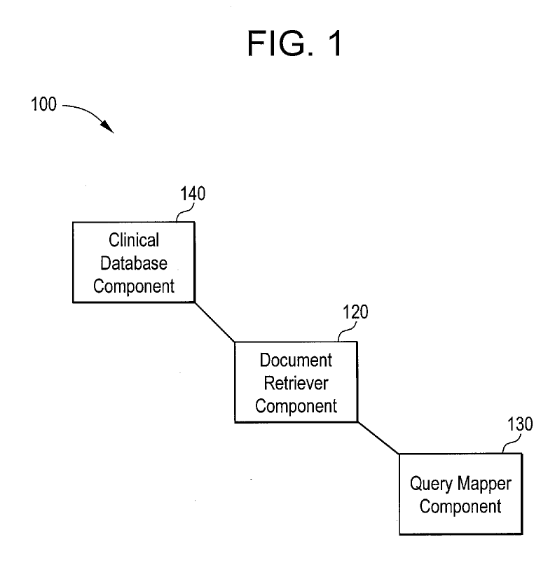

FIG. 1 illustrates a clinical document storage and locator system 100 according to an embodiment of the present invention. The system 100 includes a document retriever component 120, a query mapper component 130, and a clinical database component 140.

The document retriever component 120 is in communication with the query mapper component 130 and the clinical database component 140.

In operation, the clinical database component 140 stores one or more clinical documents received. The document retriever component 120 receives a request and determines an LOINC code using the request. The query mapper component 130 generates a document query using the determined LOINC code. The document retriever component 120 retrieves one or more relevant clinical documents from the clinical database component 140 using the generated document query.

A relevant clinical document identifier is a clinical document identifier responsive to a query, such as a document query or a user query. A relevant clinical document is a clinical document responsive to a query or search, such as a document query, a user query, or a query using a clinical document identifier or a relevant clinical document identifier.

The LOINC code may be a code for a document type and may include one or more fields, such as a kind of document field, a type of service field, a subject matter domain field, a training/professional level field, and/or a setting field, for example. In certain embodiments, descriptions for each of these fields and their potential values may be found in Regenstrief Institute, Logical Observation Names and Codes (LOINC) Users' Guide, at 57-66 (December 2007 Update). The Regenstrief Institute may be contacted at 410 West 10th St., Suite 2000, Indianapolis, Ind. 46202. The guide is available at http://www.regenstrieforg/medinformatics/loinc/downloads/files/LOINCManual.pdf The guide is herein incorporated by reference. These fields and their potential values are known in the art.

In certain embodiments, the LOINC code may also include an author role field.

The LOINC code may be associated with one or more modifier codes. A modifier code may be a date range modifier type, encounter modifier type, or item selection modifier type, for example. The date range modifier type may specify a service start time (or service start date) and a service stop time (or service end date), or a service date range. The encounter modifier type may specify an encounter or encounter identifier. The item selection modifier type may specify specific documents.

The LOINC code may specify one or more of the subject matter domain, the training/professional level, the setting, the type of service, and the kind of document. For example, an LOINC code may be Cardiology note (where Cardiology is the subject matter and note is the kind of document), Cardiology attending note (where Cardiology is the subject matter, attending is the training/professional level, and note is the kind of document), or Cardiology attending hospital admission note (where Cardiology is the subject matter, attending is the training/professional level, hospital is the setting, admission is the type of service, and note is the kind of document).

A modifier code may be 18790-6, to include all data of the selected type on or before the date of service on the claim, for example.

The request may include one or more LOINC codes, such as the LOINC code determined by the document retriever component 120, and/or one or more modifier codes. The request may be an X12N 277 request or a request for an X12N 837 claim, for example. The X12N 277 request may be a request for additional information about a claim. The request for the X12N 837 claim may be request to generate the X12N 837 claim to send to a payer, such as an insurer, the patient, a health plan provider, or another payer, for example.

The request may be sent by a healthcare provider or a payer. For example, the payer may send an X12N 277 request seeking information from a healthcare provider in order to support the payout of a claim. The payer may submit the X12N 277 request to the system 100 directly or to the healthcare provider, which then may submit the request to the system 100. As another example, the healthcare provider may seek to generate a claim for a service or product provided to a patient. The healthcare provider may submit a request for a claim to be sent to the payer or the patient, for example.

The clinical database component 140 may include one server or a network of servers, for example. In certain embodiments, the clinical database component 140 may be in communication with and retrieve clinical document identifiers and clinical documents from one or more remote clinical database components, such as healthcare provider databases, insurance provider databases, or other third-party databases, for example.

The clinical database component 140 may store one or more clinical documents. The clinical documents may relate to one or more healthcare providers and/or services or products provided by the one or more healthcare providers. The clinical documents may be documents generated by an electronic medical records (EMR) system, for example. The clinical documents may include documents created by clinicians as part of patient care. The clinical documents may include a medical record, a discharge summary, a test result, or an operative note, for example.

In certain embodiments, each clinical document stored in the clinical database component 140 may be classified using one or more query fields, LOINC codes, and/or modifier codes.

For example, each clinical document may be classified by the type of clinical document, the subject matter domain associated with the document, the type of service provided during a documented encounter, the specific clinical role of the author of the document, the level of clinical training of the author, and the practice setting. This information may be stored in the clinical database component 140, along with other data known about the document, including the location used to electronically retrieve the document, the name of the document author, the person who legally signed the document, information about the facility where the document was produced, the dates of service associated with the document, and identifiers for the encounter, patient, and document, for example.

The clinical database component 140 may include a registry and a repository. The repository may store the one or more clinical documents. The registry may store one or more clinical document identifiers, each of which may identify one of the one or more clinical documents. The document retriever component 120 may retrieve one or more relevant clinical document identifiers from the registry using the document query. The document retriever component 120 may retrieve the one or more relevant clinical documents from the clinical database component using the one or more relevant clinical document identifiers and/or the document query. The registry may be a Cross Document Sharing standard (XDS) registry, for example. The repository may be an XDS repository, for example.

The clinical document identifiers may include data from one or more of the query fields described below, including a clinical document name, a patient identifier, a kind of document, a clinical document type, a clinical document author, an author role, a type of service, a clinical subject matter, a provider role, a provider training/professional level, a practice setting, an encounter identifier, at least one date of service, and/or an electronic document location, for example.

The document retriever component 120 may further include a registry service and a repository service. The registry service may retrieve the one or more relevant clinical document identifiers from the registry using the document query. The repository service may retrieve the one or more relevant clinical documents from the clinical database component using the one or more relevant clinical document identifiers and/or the document query.

The registry and repository may comply with XDS technical requirements. The registry and repository may support Audit Trail and Node Authentication (ATNA) technical requirements, a reliable Syslog protocol, a Time Client actor from a computed tomography (CT) profile, a Time Server actor from the CT profile, and a Secure Time Server option of the CT profile.

In certain embodiments, the registry may support an XDS Minimum query set. The registry may support an XDS Registry Stored Query profile.

In certain embodiments, the registry and repository may be able to accept additional metadata about documents, folders and submission sets in an XDS transaction (e.g., additional Slots, Classifications and Associations in the Registry Objects), to support enhanced functionality. In certain embodiments, the registry and repository may not reject registrations that contain additional metadata about documents, folders and submission sets that are not previously provided for. The registry and repository may provide a registering mechanism to register documents that are specific to a site, facility, care provider, or team of providers, instead of a patient, to support enhanced functionality. The registry may support queries across patients to provide additional value.

The registry and repository may support complete backups at scheduled times. The registry and repository may support transaction logging and backup at scheduled times. The registry and repository may be configured by default for a complete nightly backup. The registry and repository may be configured by default for backups of transaction logs to be taken at least hourly. Backups made and failures to complete a backup may be logged using an ATNA profile. A warning mechanism may warn system administrators that the system has not been backed up recently. A failure to backup less frequently than daily may generate an ATNA log message at least daily.

The registry and repository may support the configuration of nodes (e.g., sources, repositories, and consumers) in an XDS Affinity domain without downtime. The registry and repository may support the configuration of nodes in the XDS Affinity domain with minimal (less than five minutes, for example) of downtime. The registry and repository may support encryption protocols for communication that are readily supported by other product platforms, in addition to those that are specified by ATNA. The registry and repository may support authentication of secure nodes (e.g., document sources and consumers) whose certificates are signed by a known certificate authority. The registry and repository may support authentication of nodes by matching the certificate to a list of known certificates. The registry may provide certificate authority functionality to support the signing of node certificates. The registry and repository may be configurable to disable the use of Transport Layer Security (TLS) between specific nodes.

The registry and repository may support a bulk load mechanism to bulk and/or batch load large numbers of documents to support loading of prior history. The bulk load mechanism may be able to process submissions.

The XDS repository may support compression of data when clinical documents are retrieved from the clinical database component 140 and/or the XDS repository. The XDS repository may support compression of information when one or more clinical documents are being retrieved from or stored in the XDS repository.

The XDS registry may support compression of information when one or more clinical document identifiers are being retrieved from or stored in the XDS registry.

The XDS registry may support easy configuration of various vocabularies used to classify types of documents, submission sets, folders, document languages, healthcare facilities, practice settings, patient types (inpatient, outpatient, or emergency department patient, for example), providers, confidentiality, and/or event codes (general purpose codes), for example. The XDS registry may support easy configuration of the patient identity domain or domains which it uses. The XDS registry may have a loading mechanism to load baseline configurations for General Electric (GE) product use, for example. The XDS registry may have a configuration mechanism to store a current configuration for creating baseline or library configurations.

The clinical database component 140 may act as a grouped XDS Document Source and an XDS Document Repository Actor, which may meet requirements of the Integrated Healthcare Environment (IHE) Information Technology Infrastructure (ITI) XDS Integration Profile for that Actor. The clinical database component 140 may support an XDS Provide and Register transaction; log exports during this transaction; support an XDS Retrieve Document transaction; log exports during this transaction; log exports according to a IHE ATNA profile; provide its own logging service; and support configuration with a centralized logging service. The XDS Retrieve Document transaction may occur when a clinical document is retrieved from the clinical database component 140.

In certain embodiments, the clinical database component 140 may maintain all documents in the form that they are retrieved by the Retrieve Document transaction. To maintain integrity of the information in the clinical document, the clinical database component 140 may return clinical documents in the same form without change for the lifetime of the clinical document. In certain embodiments, the clinical database component 140 may not dynamically transform the clinical documents during the retrieve document transaction. In those embodiments, a copy of the transformed clinical document may be saved in the clinical database component 140 for responding to retrieve document transactions. The clinical database component 140 and/or the document retriever component 120 may convert a clinical document into a CDA format. In certain embodiments, after converting the clinical document to the CDA format, the clinical document in the CDA format may be stored in the registry.

The clinical database component 140 may register documents on final sign, i.e., upon a final signature, by a legal authenticator, for example. The clinical database component 140 may be configured to perform a register documents transaction upon final sign of a clinical document. The register documents transaction may be the registration of the clinical document in the clinical database component 140. The clinical database component 140 may be configured to register only specific documents upon final sign, such as those selected by document type, author, or department, for example. This may allow the clinical database component 140 to avoid registering documents that may not be needed to attach to a claim, such as referral letters, for example, which certain healthcare provider policies may preclude from attachment to a response.

The clinical database component 140 may provide a seeding mechanism to seed the registry with clinical documents. The clinical database component 140 may be able to seed the registry with selected clinical documents that already exist in the clinical database component 140. The clinical documents used to seed the registry may be selectable by type of document, department, author, and/or date of creation. This may allow the clinical database component 140 to avoid registering documents that may not be needed to attach to a response.

The document retriever component 120 may provide a mechanism to manually register a clinical document. This may allow clinical documents that would not otherwise be attached to be shared manually when needed. To allow a user to manually select a clinical document, the document retriever component 120 may be in communication with a user interface component, such as user interface components 280 and 380 described below, for example.

The clinical database component 140 may save clinical documents in a CDA Release 2.0 format. The clinical documents may be converted to the CDA Release 2.0 format.

The clinical database component 140 may support storing section codes. The clinical database component 140 may support a section identifier mechanism of identifying sections of clinical documents using codes from the LOINC code.

The clinical database component 140 may provide data suitable for document queries. The clinical database component 140 may provide data suited to querying a registry for documents based upon claims attachment LOINC codes.

In certain embodiments, an EMR system or the clinical database component 140 may record the document class, document type, author, author specialty, author role, author training/professional level, legal authenticator, practice setting, encounter, and/or encounter dates of each clinical document at the time of creation, and use those recorded data elements when registering the clinical document. In certain embodiments, the clinical database component 140 may include an EMR system.

The vocabulary for a particular document class may be compatible with that used by the LOINC for classifying clinical documents by type of service and, when applicable, specialty, for example.

The clinical database component 140 may maintain a list of supported standard document classes.

The clinical database component 140 may be able to record the LOINC code (the LOINC document type code) for a clinical document. This LOINC code is in addition to the title of the document, and may be used for classification. The clinical database component 140 may also use a subset of LOINC codes. In certain embodiments, LOINC codes are pre-coordinated, and the setting, role and professional/training level are not used by the clinical database component 140 for document classification.

Clinical documents may be classified according to the LOINC code using the same codes that support queries for claims attachments. However, using these more specific LOINC codes may result in the need to verify that the pre-coordinated information in the LOINC code matches other metadata in the document.

The authors of the clinical document may be recorded in the clinical database component 140. The specialty (such as Gastroenterology, General Medicine, or Cardiology, for example) and role of the author (such as attending or consulting, for example) may be recorded.

The person signing (finalizing) a clinical document may be recorded as the legal authenticator. In certain embodiments, there may be only one legal authenticator recorded for a clinical document in the clinical database component 140.

The practice setting of the institution where the clinical document was created may be recorded.

The date(s) and identifier associated with an encounter may be recorded.

The clinical database component 140 may support specification of a provider's specialty (such as Oncology or Cardiology, for example) and credentials (such as MD, LPN, or DDO, for example). The clinical database component 140 may support specification of a provider's contact information: e.g., address, e-mail and telephone contact information. In certain embodiments, the clinical database component 140 may synchronize the files that identify providers.

The clinical database component 140 may support specification of the practice setting. The clinical database component 140 may support specification of the name of the organization, and contact information (e.g., address and telephone number).

The clinical database component 140 may record each registry that knows about a clinical document, i.e., contains a clinical document's clinical document identifier. When a clinical document that has been registered is amended or addended, the clinical database component 140 may register the amended or addended clinical document in each registry that knows about the original clinical document.

In certain embodiments, the registry may comply with the XDS specification as described in Version 2.0 of the IHE ITI Technical Framework. The registry may support queries on the following XDS Document Entry metadata fields: author role, author specialty, format code, and/or legal authenticator, for example. The registry may support an IHE XDS Stored Query Profile Supplement. The registry may support Claims Attachment specific stored queries. The registry may support configuration of the value sets used for various metadata fields. A standard classification scheme configuration may be supplied that provides appropriate value sets in support of the use of the XDS registry component for claims attachment purposes.

In certain embodiments, the repository may comply with the XDS specification. The repository may include an audit log repository and an audit log message service. The audit log repository may be an ATNA audit log repository. The ATNA audit log repository may conform to the ATNA specification. The ATNA audit log repository may support receipt of Berkeley Software Distribution (BSD) Syslog messages over user data protocol (UDP). The ATNA audit log repository may support configuration UDP messages larger that 1024 bytes. The ATNA audit log repository may support UDP messages of at least 32 KB in size. In certain embodiments, the ATNA audit log repository may not support reliable Syslog messages.

The audit log message service may support generation of ATNA audit log messages. The audit log message service may be responsible for formatting the message in ATNA log format. The audit log message service may be responsible for communicating the message to the audit log repository. The audit log message service may enable configuration of the audit log repository. The audit log message service may use the log message format defined in RFC-3881. In certain embodiments, the audit log message service may not use the IHE Provisional Audit Trail format. The audit log message service may be provided either as a service, or as a library component, for example.

A query field may be one of a patient identifier, a kind of document (or document class), a type of service, a clinical subject matter (or subject matter domain), a provider role, a provider training/professional level, a practice setting, an encounter identifier, at least one date of service, or an electronic document location, for example. In certain embodiments, the query field may also be one of a clinical document type, a clinical document author, an author role, or an author institution. Each query field may have subcategories.

The patient identifier may identify the patient. The clinical document type, the type of service, the clinical subject matter, the provider role, the provider training level, the provider professional level, and/or the practice setting may correspond to one or more LOINC codes. The at least one date of service may include a service start date, a service end date, and/or a service date range. The document retriever component 120 may use the electronic document location to locate and retrieve a clinical document. For example, a clinical document identifier may include an electronic document location. The document retriever component 120 may retrieve a clinical document from the repository using the electronic document location.

In certain embodiments, the clinical documents stored in the clinical database component 140 may be indexed by the query fields. Metadata associated with the query fields for each clinical document may be stored in the clinical database component 140 and/or in the registry.

A query field, such as the type of service query field and the practice setting query field, for example, may have a hierarchical structure. For example, the type of service query field may be at the top of a hierarchy. A subcategory to the type of service query field may be evaluation and management. A subcategory to the evaluation and management subcategory (and thus a sub-subcategory to the type of service query field) may be initial evaluation. A subcategory to the initial evaluation may be admission evaluation. An LOINC code may be used to generate a document query which searches for a type of service of evaluation and management, initial evaluation, or admission evaluation, for example. The hierarchical structure allows the document query to be more specific to retrieve a narrower scope of documents or less specific to retrieve a broader scope of documents.

The document retriever component 120 may retrieve a document query from the query mapper component 130 using one or more of the LOINC codes and/or modifier codes included in the request. The query mapper component 130 may use the one or more LOINC codes and/or modifier codes to generate a document query. The document query includes values or ranges for one or more query fields. The query mapper component 130 may use the one or more LOINC codes and/or modifier codes to determine the corresponding values or ranges of values for each query field. In certain embodiments, the query mapper component 130 may identify two to eight query fields as well as their corresponding values or ranges. For example, the query mapper component 130 may use the document query may have values for the kind of document, type of service, clinical subject matter, provider role, provider training/professional level, practice setting, and encounter identifier fields from an LOINC code to determine corresponding values or ranges for the kind of document, type of service, clinical subject matter, provider role, provider training/professional level, practice setting, and encounter identifier query fields.

In certain embodiments, the query mapper component 130 may use a modifier code to determine corresponding values or ranges for one or more of the query fields, such as the encounter identifier query field or the at least one date of service query field, for example. If the modifier code is a date range modifier type, the query mapper component 130 may generate a document query which includes the service dates specified in the modifier code. If the modifier code is an encounter modifier type, the query mapper component 130 may limit the document query to the encounter listed in the modifier code, for example. If the modifier code is an item selection modifier type, the query mapper component 130 may specify appropriate documents using one or more of the query fields of the document query, for example.

The query mapper component 130 may provide a mapping mechanism to map claim specific information to appropriate query parameters in the registry.

The document query may identify a patient. The document query may identify the encounter or appointment related to the claim. The document query may identify the service provider and billing provider to support matching documents for handling situations such as documents created by a physician assistant but billed by an MD, for example.

In certain embodiments, the clinical documents stored in the clinical database component 140 may be indexed by the subject matter domain, the training/professional level, the setting, and the type of service fields. The query mapper component 130 may use those four fields in the LOINC code to generate four corresponding query fields.

Clinical documents that are classified using a number of different LOINC codes may match a document query specified by a single LOINC code. The LOINC codes used for queries and classification of clinical documents need not specify all attributes among the four fields that the LOINC code may use to classify clinical documents.

The query mapper component 130 may provide a LOINC mapping mechanism to map a LOINC document type code to appropriate XDS query parameters in the registry. For example, in certain embodiments, the query mapper component 130 may map an LOINC code's kind of document field, type of service field, subject matter domain field, author role field, training/professional level field, and practice setting field to a document class query field, an event code list query field, a practice setting query field, an author role query field, an author specialty query field, and a healthcare facility type code query field, respectively, for example.

The query mapper component 130 may support classification of the kind of document by mapping into the vocabulary used for standard document classes in the registry. The query mapper component 130 may be able to identify those document classes that are Clinical Notes, i.e., clinical documents which have the value “note” in the kind of document field. The query mapper component 130 may support document classes that identify Consents and Letters, i.e., clinical documents which have the value “consent” or “letter” in the kind of document field. In certain embodiments, the query mapper component 130 may not support Legal or Reference documents.

The query mapper component 130 may support classification of type of service using a list derived from the LOINC classification system for type of service (such as communication, evaluation and management, consult, counseling, or history and physical, for example). In certain embodiments, this list may be derived from the Current Procedural Terminology, Fourth Edition, (CPT-4) codes used for Healthcare Common Procedure Coding System (HCPCS) Level I coding.

The query mapper component 130 may support classification of the subject matter domain to a vocabulary based upon the specialties described by the HIPAA Provider Taxonomy (such as General Medicine, Radiology, or Cardiology, for example). The original subject matter domain used by LOINC was based on provider specialties used in Uniform Bill-92 (UB92) and other healthcare claim forms. This domain has been superseded by the HIPAA Provider Taxonomy, which is a superset of the original LOINC domain. Specialties may be found in the fifth through eighth digits of the taxonomy codes.

The query mapper component 130 may support classification of the role of the provider who has authored the document (e.g., Attending, Consulting). The role (attending/consulting) may be confused with the Training/Professional Level in at least two cases. A Dentist, Physician, or Nurse Practitioner will always be one unless and until their license to practice is revoked. However, an Attending and Consulting physician are roles which a person with the appropriate professional level takes on with relation to a patient and a point in time, and so may be separated.

The query mapper component 130 may support classification of the training/professional level of the provider (or providers) who authored the document to a vocabulary based on the training and professional levels found in the HIPAA Provider Taxonomy (such as Dentist, Physician, or Nurse Practitioner, for example). This vocabulary may use the distinctions made in the third and fourth digits of the HIPAA Provider Taxonomy codes.

The query mapper component 130 may support classification of the practice setting using a vocabulary based on the Center for Medicare and Medicaid Services (CMS) codes for practice setting (e.g., Home, Hospital, Nursing Home, and Outpatient). This vocabulary may be compatible with other vocabularies required for HIPAA compliant claims transactions.

The query mapper component 130 may provide a maintenance mechanism to maintain and update master files used to map LOINC code values to document queries. The query mapper component 130 may support updates of individual mapping records, as well as bulk updates.

The document retriever component 120 may retrieve one or more relevant clinical documents from the clinical database component 140 using the document query. In certain embodiments, the document retriever component 120 may retrieve one or more clinical documents relating to the one or more LOINC codes and/or modifier codes associated with the request. The relevant clinical documents may be responsive to the request, such as the X12N 277 request or the request for the X12N 837 claim, for example.

The query mapper component 130 may expand the document query. By expanding the document query, the query mapper component 130 may seek all the information related to a particular value of a query field in the document query. If the document query has a value which is a sub-subcategory of a query field, the document query may be expanded at the sub-subcategory level, the subcategory level, or the category level. As an example, the document query may have a practice setting query field with a subcategory of a Hospital (Inpatient) Setting. The Hospital (Inpatient) Setting may have a subcategory of a Hospital Unit. The Hospital Unit may have a subcategory of a Critical Care Unit. If the value for the practice setting query field is the Critical Care Unit, the document query may be expanded to include additional subcategories of the Hospital Unit, such as the Emergency Department or the Observation Ward, for example. The document query may also be expanded to include other subcategories of the Hospital (Inpatient) Setting, such as the Acute Care Hospital or Rehabilitation Hospital, for example. The document query may also be expanded to include other categories of the practice setting query field, such as a Home, a Nursing Home, or an Outpatient (Office/Clinic), for example.

Certain embodiments of this invention may use off-the-shelf and/or GE developed components, such as GE IHE Client Toolkit or Eclipse Open Healthcare Framework, for example, for making queries against the clinical database component 140.

The system 100, the clinical database component 140, and the documents stored by the clinical database component 140 may be fully compatible with XDS and XDS repositories, which may allow for document sharing across a clinical enterprise. The clinical database component 140 may store documents in a hospital information system (HIS). Both XDS and HIS can store and index the documents according to multiple categorizations, such as the query fields discussed above. Embodiments of the invention provide for the mapping of elements in XDS to elements of LOINC, to facilitate storage in an XDS repository.

The document retriever component 120 may attach the one or more relevant clinical documents to a response, such as an X12N 275 response, for example. In certain embodiments, the document retriever component 120 may also perform other operations on the one or more relevant clinical documents. For example, the document retriever component 120 may select relevant clinical documents that are appropriate to an X12N 837 claim, apply further criteria as necessary, convert relevant clinical documents to an appropriate format, and/or send relevant clinical documents to a payer using the response.

The X12N 275 response may correspond to health claims attachments for sending detailed clinical information in support of claims, potentially in response to a payment denial. In certain embodiments, the 275 Response will include embedded HL7 CDA attachment data. Under CDA 2.0, the documents may be associated with at least one LOINC code. CDA is an Extensible Markup Language (XML) based standard that supports the use of non-codified data as well as codified data, and allows the continued use of LOINCs.

In certain embodiments, when an X12N 837 claim is created, an X12N 275 response may be sent with clinical documents attached to the payer.

In embodiments where the document retriever component 120 converts relevant clinical documents to the CDA 2.0 format, the document retriever component 120 may provide a header mechanism that supports generation of an appropriate CDA Release 2.0 header that is filled with the appropriate patient demographic, encounter, provider, and other information. The CDA header generated may meet minimum header requirements specified by the HL7 Care Record Summary and Continuity of Care Document Implementation Guides to support forward-looking use. The document retriever component 120 may provide a multipurpose internet mail extension (MIME) conversion mechanism that supports conversion of a clinical document of a specified MIME type into a base 64 binary encoded data stream, for example. The document retriever component 120 may provide a compression mechanism to compress the document prior to conversion to base 64. The document retriever component 120 may provide a conversion mechanism that supports conversion from a base 64 binary encoded string back into a binary data stream, for example. The document retriever component 120 may provide a decompression mechanism to decompress the data during conversion. The document retriever component 120 may be capable of handling small and large clinical documents, such as documents above or below 2 Mb in size, for example. The document retriever component 120 may directly stream the converted data to the output, or it may use (and reuse) previously allocated storage. The document retriever component 120 may avoid gratuitous creation and destruction of large data buffers for conversion, as this may degrade performance.

In certain embodiments of the invention, the response may be transmitted and/or received as part of an automated process.

The system 100 may also include and the document retriever component 120 may also be in communication with an LOINC database component, an agreement database component, a temporary storage component, and the user interface component, as discussed below.

Each of the components of the system 100 may be comprised of hardware, software, and/or firmware on a single computer or a series of networked computers. Certain embodiments of this invention may make use of off-the-shelf and/or GE developed components for registering metadata corresponding to the query fields for each clinical document, such as a GE Patient Directory, an IBM XDS Registry/Repository, and/or an IHE Operating System (OS) Registry/Repository, for example, and making queries against those components, such as a GE IHE Client Toolkit and/or an Eclipse Open Healthcare Framework, for example.

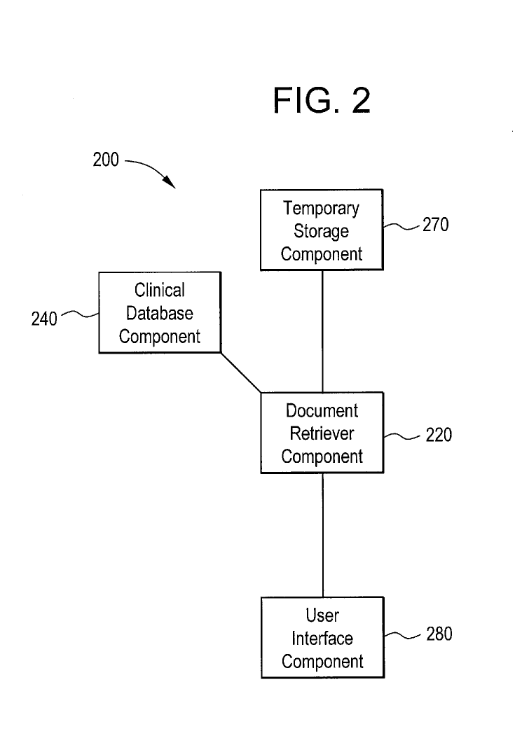

The system 100 may require the user to login to access clinical documents. The system 100 may allow its users to determine what information is appropriate to return in a claims attachment transaction. The system 100 may be configured to limit which users have access to the user interface component, such as the user interface component described below in reference to FIG. 2.

In certain embodiments, the system 100 may be adapted to meet the requirements of the Department of Health and Human Services' HIPAA Claims Attachment regulation. When clinical documents are amended or addended in the clinical database component 140, the clinical database component 140 may register the update with all registries with which it had previously registered the clinical document. When a clinical document is deleted or removed from the clinical database component 140, or reassigned to a different patient, the clinical database component 140 may take appropriate action to ensure that the one or more registries that have information about that clinical document are also informed. If a clinical document is deleted or removed, then the clinical database component 140 may replace the original document in the registry with a new document that informs the reader that the original document was deleted, and why it was deleted.

The system 100 may be compatible with GE's Centricity EMR and Centricity Business.

The components, elements, and/or functionality of the interface(s) and system(s) described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

FIG. 2 illustrates a clinical document storage and locator system 200 according to an embodiment of the present invention. The system 200 includes a document retriever component 220, a clinical database component 240, a temporary storage component 270, and a user interface component 280.

The document retriever component 220 is in communication with the clinical database component 240, the temporary storage component 270, and the user interface component 280.

In operation, the clinical database component 240 stores a plurality of clinical documents and a plurality of clinical document identifiers. The user interface component 280 receives a user query. The document retriever component 220 retrieves one or more relevant clinical document identifiers from the clinical database component 240 using the received user query. The user interface component 280 displays the one or more retrieved relevant clinical document identifiers for selection by a user. The document retriever component 220 retrieves one or more relevant clinical documents associated with the one or more retrieved relevant clinical document identifiers from the clinical database component 240. The temporary storage component 270 stores the one or more retrieved relevant clinical documents. The document retriever component 220 attaches at least one of the one or more stored relevant clinical documents to a response.

Each of the plurality of clinical document identifiers may be associated with at least one of the plurality of clinical documents.

The system 200 may be similar to the system 100 discussed above. The document retriever component 220 may be similar to the document retriever component 120 discussed above. The clinical database component 240 may be similar to the clinical database component 140 discussed above. The clinical database component 240 may comprise a repository and a registry. The repository and the registry may be similar to the repository and the registry discussed above in reference to FIG. 1. The response may be similar to the response discussed above in reference to FIG. 1.

In certain embodiments, the document retriever component 220 may be integrated with or include the temporary storage component 270. The temporary storage component 270 is adapted to store the one or more relevant clinical documents before the documents are attached to the response. The temporary storage component 270 may delete the documents after they are attached to the response. The temporary storage component 270 may include volatile memory, such as DRAM or SRAM, for example, or non-volatile memory, such as ROM, PROM, EAROM, EPROM, EEPROM, or flash memory, for example.

The user interface component 280 may be accessed through a web service bridge. The web service bridge may be a combination of hardware and/or software adapted to provide access to the user interface component 280 over the Internet. In certain embodiments, the user interface component 280 may display a web page provided by the web service bridge. The web service bridge may be adapted to process input and output. The user may use a computer or network device to interact with the web page in order to send commands to and receive results from the system 200. The web service bridge enables the integration of and communication between various systems and diversified platforms, such as query services and user interface services.

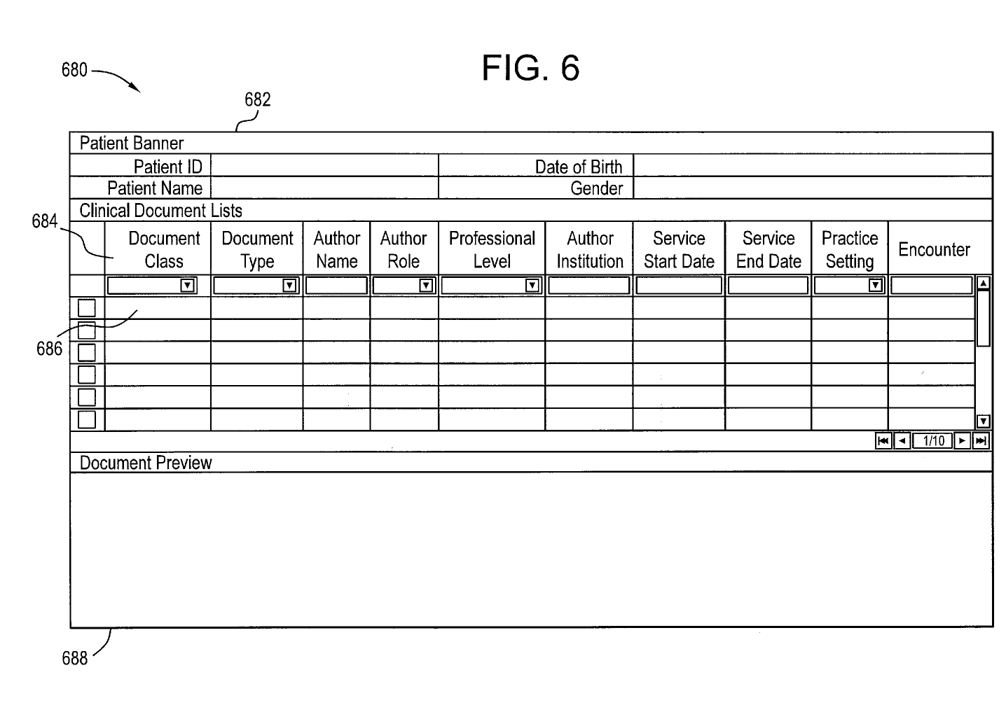

The user interface component 280 is adapted to receive a user query. The user query may include one or more query fields. The query fields may be similar to the query fields discussed above in reference to FIG. 1. The LOINC code and/or the modifier code may each be a query field or they may be mapped to query fields. The user interface component 280 may display a graphical user interface, such as the graphical user interface in FIG. 6, discussed below. The user may input the user query into the user interface component 280 using the graphical user interface. The user interface component 280 may display one or more query fields and allow the user to select and/or type in values for the query fields. Depending on the inputted values, the user interface component 280 may allow the user to select values for subcategories to the initial query fields. This process may iterate through multiple levels of sub-categorization. The user interface component 280 may also receive one or more query codes, such as one or more of an HL7 code, an X12N code, a LOINC code, and/or a modifier code, for example.

In certain embodiments, the document retriever component 220 may retrieve the one or more relevant clinical document identifiers and/or the one or more relevant clinical documents from the clinical database component 240 using the user query and/or the one or more query codes.

The repository may store the one or more clinical documents. The registry may store the one or more clinical document identifiers, each of which may identify (or be associated with) at least one of the one or more clinical documents. The document retriever component 220 may retrieve the one or more relevant clinical document identifiers from the registry using the user query. The document retriever component 220 may retrieve the one or more relevant clinical documents from the clinical database component 240 using the one or more relevant clinical document identifiers.

The user interface component 280 may graphically represent the one or more relevant clinical document identifiers by displaying a link to or a title of each relevant clinical document, for example. The user interface component 280 may provide an intuitive user interface, which provides services such as quick pagination, filter options (key-word filter/selection filter), retail document information, an attachment list, and/or a document display.

In certain embodiments, when the user interface component 280 displays the one or more relevant clinical document identifiers, the user may select a relevant clinical document identifier from the one or more displayed relevant clinical document identifiers. The document retriever component 220 may retrieve the relevant clinical document from the clinical database component 240 using the selected relevant clinical document identifier. The relevant clinical document may be associated with the selected relevant clinical document identifier. The user interface component 280 may display the relevant clinical document.

The user interface component 280 may retrieve documents from the repository and display them using the web service bridge. This may enable users to verify appropriate documents for attachment to the response. The user interface component 280 may support printing of the displayed document. The user interface component 280 may support viewing of documents from other sources, such as an Electronic Document Management system.

The user interface component 280 may enable the user to select clinical documents for a specific patient based on one or more of the following criteria: document class, type of service, author specialty, author role, training/professional level, practice setting, date(s) of service or a date range, encounter(s), provider(s), and/or LOINC code(s). The display of the query fields for selection of a user query by the user may be called a query service. Thus, the user interface component 280 may include the query service.

In certain embodiments, the user interface component 280 may display user-friendly information rather than codes or identifiers, such as provider names, for example, even if the actual query is performed using provider identifiers. In certain embodiments, the user interface component 280 may be launch-able by other components with a predefined query to be executed. The user interface component 280 may support queries across more than one registry. In certain embodiments, the user interface component 280 may map queries to the appropriate vocabularies used by each registry. The user interface component 280 may display a count or an approximate count of the number of documents that would be retrieved using the user query.

The user interface component 280 may display the following information for each result of a query: document class code and name, document type code, document name, author name, author role and training/professional level, author institution, service date range, subject matter domain, and/or encounter. The display of the results, the relevant clinical documents, and/or the relevant clinical document identifiers may be called a viewer service. Thus, the user interface component 280 may include the viewer service. The user interface component 280 may support dynamic configuration of the fields to display, including the order and width of fields, use of grouping, and sorting (as in a tree-list control, for example). The user interface component 280 may save the current configuration for the user upon subsequent entry into the viewer. The user interface component 280 may support organization of the results by XDS Folder or Submission Set (as in a tree control, for example).

The user interface component 280 may support selection of one or more clinical documents for further processing (such as attachment to a response, for example). A list of selected documents may be retained by the user interface component 280 until the user has dismissed it. In certain embodiments, the selected documents may be stored in the temporary storage component 270. Upon dismissal, the user interface component 280 may return the selected documents to the document retriever component 220 for further processing.

In certain embodiments, the user interface component 280 may display the one or more relevant clinical documents retrieved from the clinical database component 240.

The user interface component 280 may provide a launching mechanism to support launching a document viewer with a relevant clinical document associated with the selected relevant clinical document identifier. The document viewer may display the relevant clinical document. The user interface component 280 may include the document viewer.

The user interface component 280 may support refinement and/or revision of the user query to locate appropriate clinical documents.

The user interface component 280 may include tools to update master files used for mapping LOINC codes to queries. The master files may be similar to the master files described above in reference to FIG. 1. LOINC data used by GE's EMR and other GE Healthcare applications may be synchronized with these master files. There may be a user interface to maintain the LOINC master file data, such as the user interface component 280, for example. There may be tools to support upgrades to the system 200.

In certain embodiments, the document retriever component 220 may store in the temporary storage component 270 one or more of the one or more relevant clinical documents being displayed or having its identifiers displayed via the user interface component 280.

If the user interface component 280 is displaying relevant clinical document identifiers, the user may select one or more of the displayed relevant clinical document identifiers and the document retriever component 220 may retrieve the relevant clinical document from the repository in the clinical database component 240. In certain embodiments, the document retriever component 220 may store the retrieved relevant clinical documents in the temporary storage component 270.

If the user interface component 280 is displaying relevant clinical documents, the user may select one or more of the displayed relevant clinical documents. In certain embodiments, the document retriever component 220 may store the one or more user selected relevant clinical documents in the temporary storage component 270.

The user interface component 280 may allow the user to view the one or more relevant clinical documents. The user may select a relevant clinical document to view and the user interface component 280 may display the relevant clinical document. If the relevant clinical document is stored in the temporary storage component 270, the user interface component 280 does not need to access the clinical database component 240 to retrieve the relevant clinical document for display.

In certain embodiments, when the document retriever component 220 attaches a relevant clinical document to the response, the document retriever component 220 may first attempt to retrieve the relevant clinical document from the temporary storage component 270. The retrieval of documents from the temporary storage component 270 is faster than the retrieval of documents from the clinical database component 240. If the temporary storage component 270 does not have the relevant clinical document, the document retriever component 220 may then retrieve the relevant clinical document from the clinical database component 240.

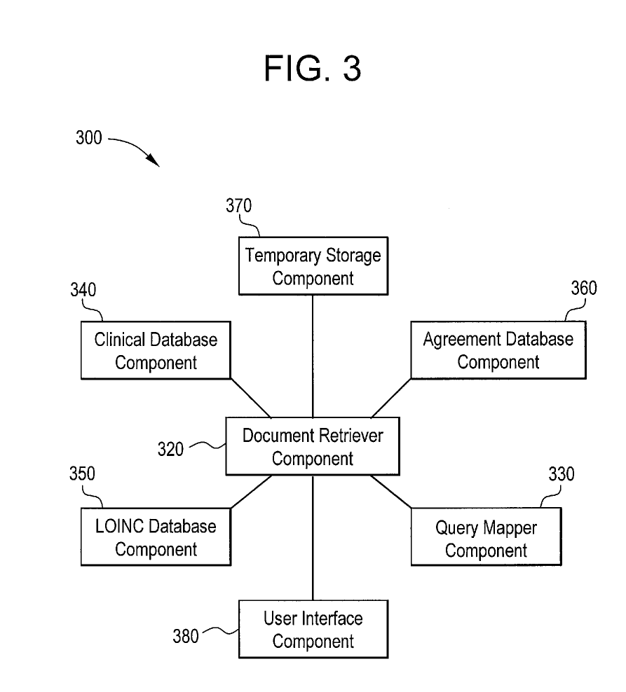

The system 200 may also include a query mapper component, an LOINC database component, and an agreement database component, as discussed below in reference to FIG. 3.

The components, elements, and/or functionality of the interface(s) and system(s) described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

FIG. 3 illustrates a clinical document storage and locator system 300 according to an embodiment of the present invention. The system 300 includes a document retriever component 320, a query mapper component 330, a clinical database component 340, an LOINC database component 350, an agreement database component 360, a temporary storage component 370, and a user interface component 380.

The document retriever component 320 is in communication with the query mapper component 330, the clinical database component 340, the LOINC database component 350, the agreement database component 360, the temporary storage component 370, and the user interface component 380.

The system 300 may be similar to the systems 100 and 200 discussed above. The document retriever component 320 may be similar to the document retriever component 120 and the document retriever component 220 discussed above. The query mapper component 330 may be similar to the query mapper component 130 and the query mapper component discussed above in reference to FIG. 2. The clinical database component 340 may be similar to the clinical database component 140 and the clinical database component 240 discussed above. The clinical database component 340 may include a repository and a registry. The repository and the registry may be respectively similar to the repository and the registry discussed above in reference to FIGS. 1 and 2. The temporary storage component 370 may be similar to the temporary storage component 270 and the temporary storage component discussed above in reference to FIG. 1. The user interface component 380 may be similar to the user interface component 280 and the user interface component discussed above in reference to FIG. 1.

In operation, the clinical database component 340 stores one or more clinical documents and one or more clinical document identifiers, each of which may be associated with at least one of the clinical documents. In certain embodiments, the document retriever component 320 may retrieve one or more relevant clinical document identifiers from the clinical database component 340 using a query. In certain embodiments, the document retriever component 320 may retrieve one or more relevant clinical documents from the clinical database component 340 using a query and/or the one or more relevant clinical document identifiers. The query may be a document query or a user query. The query mapper component 330 generates a document query using an LOINC code determined by the document retriever component 320. The user interface component 380 receives the user query. The user interface component 380 displays the one or more relevant clinical documents and/or the relevant clinical document identifiers for selection by the user. The temporary storage component 370 stores the user selected relevant clinical documents and/or relevant clinical documents associated with selected relevant clinical document identifiers. The agreement database component 360 stores one or more partner agreements. The request is associated with a partner agreement. Each partner agreement is associated with one or more clinical document lists. The document retriever component 320 attaches one or more of the stored relevant clinical documents to a response using the clinical document list associated with the request.

The clinical documents and the clinical document identifiers may be similar to the clinical documents and clinical document identifiers discussed above in reference to FIGS. 1 and 2. The document query may be similar to the document query discussed above in reference to FIG. 1. The user query may be similar to the user query discussed above in reference to FIG. 2. The relevant clinical documents and the relevant clinical document identifiers may be respectively similar to the relevant clinical documents and the relevant clinical document identifiers discussed above in reference to FIGS. 1 and 2.

The document retriever component 320 may determine the LOINC code using the request, the LOINC database component 350, or the user interface component 380. In certain embodiments, the document retriever component 320 may determine the LOINC code using the agreement database component 360, as described below.

The request may include the LOINC code and/or a modifier code, as discussed above. The document retriever component 320 may retrieve the included LOINC code. The LOINC code and the modifier code may be respectively similar to the LOINC code and the modifier code discussed above in reference to FIGS. 1 and 2.

In operation, the LOINC database component 350 stores one or more LOINC codes and/or one or more modifier codes. Each LOINC code may be indexed by four fields, for example. The LOINC database component 350 can be queried on the individual fields comprising the LOINC code, using an LOINC query. The LOINC database component 350 may return one or more LOINC codes and/or one or more modifier codes based on the LOINC query. The LOINC query may be generated by the document retriever component 320 using the request or information received from the user via the user interface component 380. The document retriever component 320 may retrieve the generated LOINC code.

The user may enter the LOINC code using the user interface component 380. The document retriever component 320 may retrieve the entered LOINC code.

The document retriever component 320 may retrieve a clinical document list associated with the request from the agreement database component 360.

In operation, the agreement database component 360 stores one or more partner agreements. Each partner agreement may be an agreement between a healthcare provider and an insurer or payer. Each partner agreement may relate to fees, payment schedules, and/or documentation required to process a claim or a request for additional information. Each partner agreement may include a clinical document list. Each clinical document list identifies one or more clinical document types which are required to be sent in a response, such as an X12N 837 claim or an X12N 275 response, for example. An insurance company may require the provider to send specific documents relating to each service performed by the provider, for example. These requirements may be stored in the partner agreement. Thus, when an X12N 837 claim is originated, the agreement database may be used to determine which supporting clinical documents to transmit to the payer.

In certain embodiments, the agreement database component 260 may store LOINC and/or modifier codes associated with one or more of the partner agreements. The document retriever component 320 may retrieve one or more of the LOINC and/or modifier codes associated with the response. The document retriever component 320 may use the codes to generate a document query using the query mapper component 330.

In certain embodiments, the document retriever component 320 may use the agreement database component 360 to generate the document query. The clinical document list associated with a response, such as the X12N 837 claim, may be used to aid in the generation of the document query. For example, the clinical document list may provide values for the clinical document type query field.

In certain embodiments, the user interface component 380 may use the agreement database component 360 to select which of the relevant clinical documents to display. For example, in certain embodiments, the user interface component 380 may only display relevant clinical documents of the clinical document types listed in the clinical document list associated with the response.

In certain embodiments, certain components of the system 300 are not included. For example, in certain embodiments, the system 300 does not include the temporary storage component 370.

The components, elements, and/or functionality of the interface(s) and system(s) described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

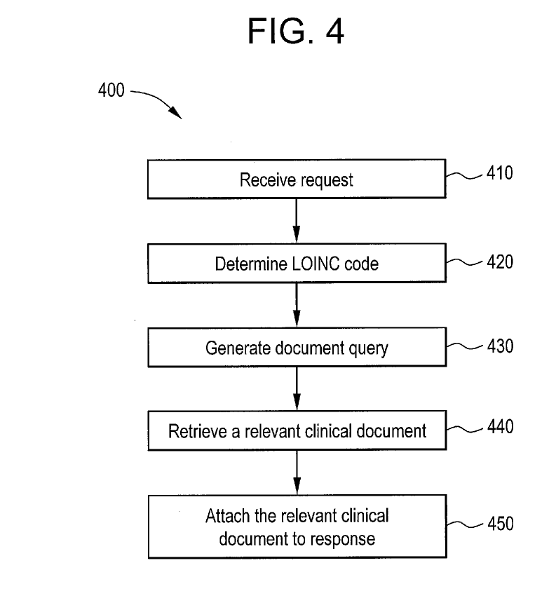

FIG. 4 illustrates a flow diagram for a method 400 for locating claim reimbursement attachments according to an embodiment of the present invention. The method 400 includes the following steps, which will be described below in more detail. At step 410, a request is received. At step 420, an LOINC code is determined using the received request. At step 430, a document query is generated using the determined LOINC code. At step 440, a relevant clinical document is retrieved from a clinical database component using the generated document query. At step 450, the retrieved relevant clinical document is attached to a response. The method 400 is described with reference to elements of systems described above, but it should be understood that other implementations are possible.

At step 410, the request is received. The request may be similar to the request discussed above in reference to FIGS. 1, 2, and 3. The request may be received by a document retriever component. The document retriever component may be similar to the document retriever component 120, 220, and 320 discussed above.

At step 420, the LOINC code is determined using the received request. In certain embodiments, the request may include the LOINC code. The document retriever component also may determine the LOINC code by retrieving it from the request or an LOINC database component, for example. The LOINC database component may be similar to the LOINC database component 350 discussed above.

At step 430, the document query is generated using the determined LOINC code. The document query may be similar to the document query discussed above in reference to FIGS. 1, 2, and 3.

In certain embodiments, a query mapper component may generate the document query using the LOINC code. The query mapper component may be similar to the query mapper component 130 and 330 discussed above. The document retriever component may retrieve the document query from the query mapper component.

In certain embodiments, a user may input a document query using a user interface component. In those embodiments, the document query may be similar to the user query discussed above in reference to FIGS. 2 and 3. The user interface component may be similar to the user interface component 280 and 380 discussed above. The document retriever component may retrieve the document query from the user interface component.

In certain embodiments, the determining step 420 may include determining a modifier code using the request. The modifier code may be similar to the modifier code discussed above in reference to FIGS. 1, 2, and 3. The request may include the modifier code. The document retriever component may determine the modifier code by retrieving it from the request or the LOINC database component, for example. The generating step 430 may be performed using the modifier code. The query mapper component may use the modifier code to generate the document query.

At step 440, the relevant clinical document is retrieved from the clinical database component using the generated document query. In certain embodiments, the document retriever component retrieves the relevant clinical document from a clinical database component using the document query. The clinical database component may be similar to the clinical database component 140, 240, and 340 discussed above. Each relevant clinical document may be similar to the relevant clinical document discussed above in reference to FIGS. 1, 2, and 3.

The clinical database component may include a repository and a registry. The repository and the registry may be respectively similar to the repository and the registry discussed above in reference to FIGS. 1, 2, and 3. The repository may store the one or more clinical documents. The registry may store one or more clinical document identifiers, each of which may identify and/or be associating one of the one or more clinical documents. The clinical document identifiers may be similar to the clinical document identifiers discussed above in reference to FIGS. 1 and 2.

In certain embodiments, at step 440, the document retriever component may retrieve one or more relevant clinical document identifiers from the registry using the document query. The user interface component may display the one or more relevant clinical document identifiers. The user may select a relevant clinical document identifier from the one or more relevant clinical document identifiers. The document retriever component may retrieve the relevant clinical document from the repository of the clinical database component using the selected relevant clinical document identifier.

In certain embodiments, the document retriever component may cache the relevant clinical document in a temporary storage component. The temporary storage component may be similar to the temporary storage component 270 and 370 described above.

At step 450, the retrieved relevant clinical document is attached to the response. The document retriever component may attach the relevant clinical document to the response. The response may be similar to the response discussed above in reference to FIGS. 1, 2, and 3. In certain embodiments, the document retriever component may attach the relevant clinical document to the response. In certain embodiments, the document retriever component may send the response to a sender of the request, an insurance provider, or a healthcare services payer, for example.

In certain embodiments, the document retriever component may use a clinical document list associated with the request to determine whether to attach the relevant clinical documents. The clinical document list may be similar to the clinical document list described above in reference to FIG. 3. The document retriever component may retrieve the clinical document list from an agreement database component. The agreement database component may be similar to the agreement database component 360 discussed above in reference to FIG. 3. The agreement database component may store one or more partnership agreements. Each partnership agreement may include a clinical document list. The request may be associated with a partnership agreement. The document retriever component may use the request to retrieve the clinical document list.

In certain embodiments, the step 450 may further include formatting the relevant clinical document. The document retriever component may convert the relevant clinical document to an appropriate format. For example, the document retriever component may convert the relevant clinical document to a CDA Release 2.0 format. The relevant clinical document may also conform to HL7 Claims Attachment Guides. The document retriever component may apply transformations to CDA Release documents to add material specific to claims attachments, such as an Attachment Control Number, for example.

In certain embodiments, the step 450 may further include selecting the relevant clinical document using the user interface component.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

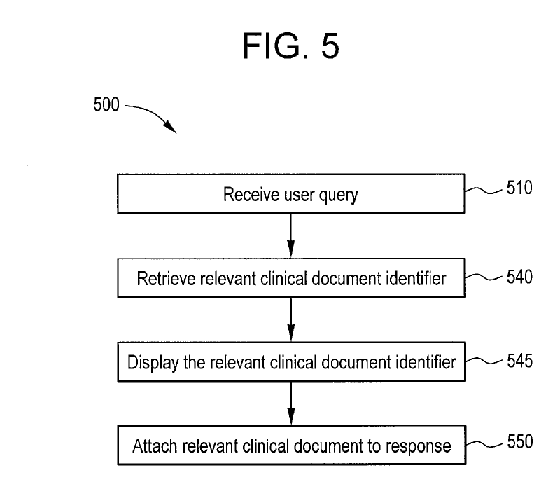

FIG. 5 illustrates a flow diagram for a method 500 for locating claim reimbursement attachments according to an embodiment of the present invention. The method 500 includes the following steps, which will be described below in more detail. At step 510, a user query is received. At step 540, a relevant clinical document identifier is retrieved from a clinical database component using the received user query. At step 545, the relevant clinical document identifier is displayed for selection by a user. The relevant clinical document identifier is associated with a relevant clinical document. At step 550, the relevant clinical document is attached to a response. The method 500 is described with reference to elements of systems described above, but it should be understood that other implementations are possible.

At step 510, the user query is received. The user query may be similar to the user query described above in reference to FIGS. 2, 3, and 4. The user query may be received by a user interface component. The user interface component may be similar to the user interface component 280 and 380, and the user interface component described in reference to FIG. 4.

In certain embodiments, at step 510, a request may be received. The request may be similar to the request described above in reference to FIGS. 1, 2, 3, and 4. The request may be received by the user interface component or a document retriever component. The document retriever component may be similar to the document retriever component 120, 220, and 320, and the document retriever component discussed above in reference to FIG. 4.

At step 540, the relevant clinical document identifier is retrieved from a clinical database component using the user query. The document retriever component may retrieve the relevant clinical document identifier from the clinical database component using the user query. The clinical database component may be similar to the clinical database component 140, 240, and 340, and the clinical database component described in reference to FIG. 4.

The clinical database component may include a repository and a registry. The repository and the registry may be respectively similar to the repository and the registry discussed above in reference to FIGS. 1, 2, 3, and 4. The repository may store one or more clinical documents. The registry may store one or more clinical document identifiers, each of which may identify one of the one or more clinical documents. The clinical document identifiers may be similar to the clinical document identifiers discussed above in reference to FIGS. 1, 2, 3, and 4. The relevant clinical document identifier may be similar to the relevant clinical document identifier discussed above in reference to FIGS. 1, 2, 3, and 4.

At step 545, the relevant clinical document identifier is displayed for selection by a user. The relevant clinical document identifier is associated with a relevant clinical document. The user interface component may display the relevant clinical document identifier and/or the title of the relevant clinical document identified by the relevant clinical document identifier.

In certain embodiments, the user may select the relevant clinical document identifier. The document retriever component may retrieve the relevant clinical document from the repository of the clinical database component using the selected relevant clinical document identifier. In certain embodiments, the displaying step 545 may further include displaying the retrieved relevant clinical document on the user interface component.

In certain embodiments, the displaying step 545 may further include caching the relevant clinical document. The document retriever component may store the relevant clinical document in a temporary storage component. The temporary storage component may be similar to the temporary storage component 270 and 370 described above and the temporary storage component described above in reference to FIG. 4.

At step 550, the relevant clinical document is attached to the response. The document retriever component may attach the relevant clinical document to the response. The relevant clinical document may be similar to the relevant clinical document discussed above in reference to FIGS. 1, 2, 3, and 4. The response may similar to the response discussed above in reference to FIGS. 1, 2, 3, and 4.

In certain embodiments, the document retriever component may retrieve the relevant clinical document from the temporary storage component. In certain embodiments, the document retriever component may retrieve the relevant clinical document from the clinical database component. The step 550 may be similar to the step 450 described above.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

FIG. 6 illustrates a user interface 680 according to an embodiment of the present invention. The user interface 680 includes a patient banner 682, a plurality of query fields 684, a document list 686, and a document preview 688.

The user interface 680 is generated by a user interface component. The user interface component may be similar to the user interface component 280 and 380 described above and the user interface component described above in reference to FIGS. 1, 4, and 5.

In operation, the patient banner 682 displays patient identifiers, such as a patient ID, a patient name, a patient date of birth, and a patient gender, for example. Each of the plurality of query fields 684 may be similar to the query fields discussed above in reference to FIGS. 1, 2, and 3. The plurality of query fields includes at least one of a document class query field, a clinical document type query field, a clinical document author query field, a type of service query field, a clinical subject matter query field, a provider role query field, a provider training level query field, a provider professional level query field (a provider training/professional level query field), a practice setting query field, an encounter identifier query field, a date of service query field, a service start date query field, a service end date query field, and an electronic document location query field. The user may enter query data into the plurality of query fields 684. The entered query data may comprise the user query. The user query may be similar to the user query discussed above in reference to FIGS. 2, 3, 4, and 5.

Each of the plurality of query fields 684 may have a drop-down menu reciting one or more query data options. The one or more query data options may be generated by the user interface component using the entered query data and/or the patient identifier data. The user interface component may be in communication with and use a query mapper component to generate the query data options. The query mapper component may be similar to the query mapper component 130 and 330, and the query mapper component discussed above in reference to FIG. 4.

In certain embodiments, the patient banner 682 allows a user to input patient identifiers into the user interface 680. The inputted patient identifiers may comprise a user query, such as the user query discussed above in reference to FIGS. 2, 3, and 5. A document retriever component may retrieve the inputted patient identifiers and use their data to retrieve one or more relevant clinical document identifiers from a clinical database component. The document retriever component may be similar to the document retriever component 120, 220, and 320, and the document retriever component discussed above in reference to FIGS. 4 and 5. The clinical database component may be similar to the clinical database component 140, 240, and 340, and the clinical database component described above in reference to FIGS. 4 and 5.

In operation, the document list 686 displays a list of the one or more relevant clinical document identifiers.

The user may change the query data in each of the plurality of query fields 684. A change in the query data may change which document identifiers the user interface 680 displays. For example, if the user interface 680 is displaying all the relevant clinical document identifiers for a certain patient, entering query data in the clinical document type query field may cause the document list 686 to only display the relevant clinical document identifiers of that document type for the patient. Thus, the user may filter or sort the relevant clinical document identifiers displayed in the document list 686 using the plurality of query fields. If the relevant clinical documents do not all fit in the document list 686, the user may page through the document identifiers or scroll through the document identifiers using a vertical scroll bar. To retain a particular relevant clinical document identifier, the user may select a check box displayed next to the relevant clinical document identifier in the document list 686.

The user may select a relevant clinical document identifier. The document preview 688 provides the user with a view of a relevant clinical document associated with the selected relevant clinical document identifier from the document list 686.

The user interface component may include a query service and a viewer service. The query service may be similar to the query service discussed above in reference to FIG. 2. The viewer service may be similar to the viewer service discussed above in reference to FIG. 2. The query service may display the plurality of query fields 684 and the document list 686. The viewer service may display the relevant clinical document associated with the selected relevant clinical document identifier.

In certain embodiments, the patient banner 682, the plurality of query fields 684, the document list 686, and the document preview 688 may each be a frame in the user interface 680.

The components, elements, and/or functionality of the interface(s) and system(s) described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

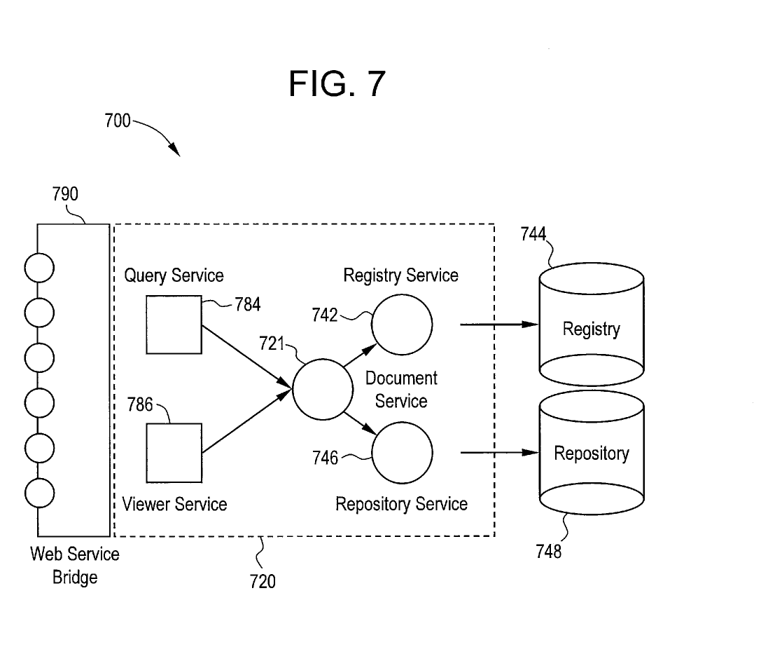

FIG. 7 illustrates a clinical document storage and locator system 700 according to an embodiment of the present invention. The system 700 includes a document retriever component 720, a web service bridge 790, a registry 744, and a repository 748. The document retriever component 720 includes a query service 784, a viewer service 786, a document service 721, a registry service 742, and a repository service 746.

The web service bridge 790 is in communication with the document retriever component 720. The document retriever component 720 is in communication with the registry 744 and the repository 748. The document service 721 is in communication with the query service 784, the viewer service 786, the registry service 742, and the repository service 746. The registry service 742 is in communication with the registry 744. The repository service 746 is in communication with the repository 746.

The system 700 may be similar to the systems 100, 200, and 300 discussed above. The document retriever component 720 may be similar to the document retriever component 120, 220, and 320, and the document retriever component discussed above in reference to FIGS. 4 and 5. The query service may be similar to the query service discussed above in reference to FIGS. 2 and 6, the query mapper component 130, the query mapper component discussed above in reference to FIG. 2, and the query mapper component 330. The registry service 742 may be similar to the registry service discussed above in reference to FIG. 1. The registry 744 may be similar to the registry discussed above in reference to FIGS. 1, 2, 3, 4, 5, and 6 and the clinical database components 140, 240, and 340. The repository service 746 may be similar to the repository service discussed above in reference to FIG. 1. The repository 748 may be similar to the repository discussed above in reference to FIGS. 1, 2, 3, 4, 5, and 6 and the clinical database components 140, 240, and 340. The viewer service 786 may be similar to the viewer service discussed above in reference to FIGS. 2 and 6. The web service bridge 790 may be similar to the web service bridge described above in reference to FIG. 2.

In operation, the web service bridge 790 provides a user access to the document retriever component 720. The query service 784 of the document retriever component 720 allows the user to enter a user query. The user query may be similar to the user query discussed above in reference to FIGS. 2 and 5. The user query may be sent to the document service 721. The document service 721 may use the registry service 742 to query the registry 744 with the user query. The registry 744 may return a relevant clinical document identifier associated with a relevant clinical document based at least in part on the user query. The viewer service 786 may display the relevant clinical document identifier. The user may select the relevant clinical document identifier to view the relevant clinical document. The document service 721 may retrieve the relevant clinical document associated with the selected relevant clinical document identifier from the repository 748 using the repository service 746. The viewer service 786 may display the retrieved relevant clinical document. The user may select the relevant clinical document to be attached to a response. The response may be similar to the response discussed above in reference to FIGS. 1, 2, 3, 4, and 5.

For example, in certain embodiments, a user may submit to the document retriever component 720 a request for an X12N 837 claim for payment concerning patient John Smith's outpatient visit to his cardiologist at his doctor's office. The request may include an LOINC code of Cardiology physician outpatient note. A query mapper component, which is similar to the query mapper component 130 and the query mapper component 330, may generate a document query using the LOINC code. The query mapper component is in communication with the document retriever component 720. The document query may include a clinical subject matter query field value of cardiology, a training/professional level query field value of physician, a practice setting query field value of outpatient, a kind of document query field value of clinical note, and a patient identifier query field value of John Smith. The document retriever component 720 may search the registry 744 of a clinical database component, which is similar to the clinical database components 140, 240, and 340, using the document query. The document retriever component 720 may return two clinical document identifiers, each of which identify clinical notes which involve the subject matter of cardiology and were written by a physician in an outpatient practice setting concerning a patient named John Smith. The document retriever component 720 may display the two clinical document identifiers on a user interface using a user interface component, which is similar to the user interface component 280 and the user interface component 380. The user interface component is in communication with the document retriever component 720. The user interface component may display each document's name, kind, subject matter domain, training/professional level of the provider, practice setting, and patient name. The user interface component may also display the dates of service for the two documents. A user may select one of the two clinical document identifiers to view the clinical document associated with the selected clinical document identifier. The document retriever component 720 may retrieve the clinical document associated with the selected clinical document identifier from the repository 748 of the clinical database component. The user interface component may display the retrieved clinical document. The document retriever component 720 may store the retrieved clinical document in a temporary storage component, similar to the temporary storage component 270 and the temporary storage component 370. The document retriever component 720 is in communication with the temporary storage component. The user may select the displayed clinical document to be attached to the claim using the user interface component. The document retriever component 720 may generate the X12N 837 claim, retrieve the stored clinical document from the temporary storage component, format the stored clinical document in CDA 2.0 format, attach the formatted clinical document to the X12N 837 claim, and send the X12N 837 claim to the patient's insurance company.

In the above example, the user interface component may also display the document query in query fields of the user interface. The user may change the query fields. When the user changes the query fields, the document retriever component 720 may search the registry again using the new query fields, which form the document query. The document retriever component 720 may then retrieve and display any clinical document identifiers, which are responsive to the document query, on the user interface component.

The components, elements, and/or functionality of the interface(s) and system(s) described above may be implemented alone or in combination in various forms of hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

The present invention generally relates to clinical document management systems. More specifically, the present invention relates to systems and method for storing and locating claim reimbursement attachments.

Thus, certain embodiments of the present invention provide for a clinical document storage and locator system. Further, certain embodiments of the present invention provide a method for locating claim reimbursement attachments. Certain embodiments of the present invention use LOINC codes to identify and retrieve clinical documents. Certain embodiments provide a technical effect of locating claim reimbursement attachments using an LOINC code. Certain embodiments provide a technical effect of locating claim reimbursement attachments using a user query.

In the present specification, use of the singular includes the plural except where specifically indicated. In the present specification, any of the functions recited herein may be performed by one or more means for performing such functions.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN), which are presented here by way of example and not limitation. Such networking environments are commonplace in office-wide or enterprise-wide computer networks, intranets, and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A clinical document storage and locator system, the system comprising:
a clinical database component adapted to store a plurality of clinical documents;
a document retriever component adapted to receive a request, wherein the document retriever component is further adapted to determine an LOINC code using the received request; and
a query mapper component adapted to generate a document query using the determined LOINC code, wherein the document retriever component is adapted to retrieve a relevant clinical document from the clinical database component using the generated document query.

2. The system of claim 1, wherein the request comprises the LOINC code.

3. The system of claim 2, wherein the request further comprises a modifier code, and wherein the query mapper component is further adapted to generate the document query using the modifier code.

4. The system of claim 1, wherein the system further comprises:
an LOINC database component adapted to store a plurality of LOINC codes, and wherein the document retriever component is further adapted to determine the LOINC code using the LOINC database component.

5. The system of claim 1, wherein the document query comprises at least one of a patient identifier, a clinical document type, a type of service, a clinical subject matter, a provider role, a provider training level, a provider professional level, a practice setting, an encounter identifier, at least one date of service, and an electronic document location.

6. The system of claim 1, wherein the clinical database component comprises a registry and a repository, wherein the document retriever component is further adapted to retrieve a relevant clinical document identifier from the registry using the document query, and wherein the document retriever component is further adapted to retrieve the relevant clinical document from the clinical database component using the relevant clinical document identifier.

7. The system of claim 1, wherein the request comprises an X12N 277 request.

8. The system of claim 1, wherein the system further comprises:
an agreement database component adapted to store a plurality of partner agreements, wherein each partner agreement is adapted to include a clinical document list, wherein the request is associated with a partner agreement, and wherein the document retriever component is further adapted to use the clinical document list associated with the request to attach the relevant clinical document to a response.

9. The system of claim 1, wherein the clinical database component is further adapted to store a plurality of clinical document identifiers, wherein each of the plurality of clinical document identifiers is associated with at least one of the plurality of clinical documents, wherein the document retriever component is further adapted to retrieve a relevant clinical document identifier from the clinical database component using the document query, and wherein the document retriever component is further adapted to retrieve the relevant clinical document from the clinical database component using the relevant clinical document identifier.

10. The system of claim 9, wherein the system further comprises:
a user interface component adapted to display the relevant clinical document identifier for selection by a user, and wherein the document retriever component is further adapted to attach the relevant clinical document to a response.

11. The system of claim 10, wherein the user interface component is further adapted to display the relevant clinical document.

12. The system of claim 1, wherein the document retriever component is further adapted to attach the relevant clinical document to a response.

13. The system of claim 12, wherein the response comprises at least one of an X12N 275 response and an X12N 837 claim.

14. A clinical document storage and locator system, the system comprising:
a clinical database component adapted to store a plurality of clinical documents and a plurality of clinical document identifiers;
a user interface component adapted to receive a user query;
a document retriever component adapted to retrieve a relevant clinical document identifier from the clinical database component using the received user query, wherein the user interface component is adapted to display the retrieved relevant clinical document identifier for selection by a user, and wherein the document retriever component is further adapted to retrieve a relevant clinical document associated with the displayed relevant clinical document identifier from the clinical database component; and
a temporary storage component adapted to store the retrieved relevant clinical document, wherein the document retriever component is further adapted to attach the stored relevant clinical document to a response.

15. A method for locating claim reimbursement attachments, the method comprising:
receiving a request;
determining an LOINC code using the request;
generating a document query using the LOINC code; and
retrieving a relevant clinical document from a clinical database component using the document query.

16. The method of claim 15, wherein the method further comprises the step of attaching the relevant clinical document to a response.

17. The method of claim 16, wherein the attaching step further comprises formatting the relevant clinical document.

18. The method of claim 16, wherein the attaching step is performed using a clinical document list retrieved from an agreement database component.

19. The method of claim 16, wherein the attaching step further comprises displaying the relevant clinical document using a user interface component.

20. The method of claim 15, wherein the retrieving step further comprises:
retrieving a relevant clinical document identifier from a registry using the document query, wherein the clinical database component comprises the registry and a repository; and
retrieving the relevant clinical document from the repository using the relevant clinical document identifier.

21. The method of claim 15, wherein the determining step further comprises determining a modifier code using the request, and wherein the generating step is performed using the modifier code.

22. The method of claim 15, wherein the request comprises the LOINC code.

23. A method for locating claim reimbursement attachments, the method comprising:
receiving a user query;
retrieving a relevant clinical document identifier using the user query;
displaying the relevant clinical document identifier for selection by a user, wherein the relevant clinical document identifier is associated with a relevant clinical document;
retrieving the relevant clinical document;
caching the retrieved relevant clinical document; and
attaching the cached relevant clinical document to a response.

24. A computer-readable medium comprising a set of instructions for execution on a computer, the set of instructions comprising:
a receiver routine configured to receive a request;
an LOINC routine configured to determine an LOINC code using the request;
a generation routine configured to generate a document query using the determined LOINC code; and
a retrieval routine configured to retrieve a relevant clinical document from a clinical database component using the generated document query.
